(19) United States
(12) Patent Application Publication
(10) Pub. No.: US 2024/0129309 A1
(43) Pub. Date: Apr. 18, 2024

(54) DISTRIBUTED DEVICE TRUST DETERMINATION

(71) Applicant: Wells Fargo Bank, N.A., San Francisco, CA (US)

(72) Inventors: Upul D. Hanwella, San Francisco, CA (US); Ann M. Kirk, Deerwood, MN (US); Ravi Thota, San Francisco, CA (US); Shawn Patrick Clark, Hastings, MN (US); Azita Asefi, Vacaville, CA (US); Alan W. Hecht, Chanhassen, MN (US); Anand Gopalan Kidambi, Dublin, CA (US)

(21) Appl. No.: 18/488,771

(22) Filed: Oct. 17, 2023

Related U.S. Application Data
(60) Provisional application No. 63/379,880, filed on Oct. 17, 2022.

(51) Int. Cl. H04L 9/40

(52) U.S. Cl. CPC H04L 63/0876; H04L 63/102; H04L 63/105

(57) ABSTRACT

Techniques described herein include performing a distributed device trust determination that includes determining trust scores for customer devices across multiple organizations. In one example, this disclosure describes a method that includes receiving data of a user device event including an organization confidence level for a user device associated with the user device event; updating common data in an entry for the user device in a device registry based on the received data of the user device event and the organization confidence level for the user device; determining a common confidence level for the user device based on the common data in the entry for the user device in the device registry; and outputting the common confidence level for the user device for use by the computing device of the first organization to determine how to handle an access request from the user device.

This application claims the benefit of U.S. Provisional Patent Application No. 63/379,880, filed Oct. 17, 2022, the entire contents of which is incorporated herein by reference.

### TECHNICAL FIELD

This disclosure relates to computer networks, and more specifically, to fraud identification and/or mitigation.

### BACKGROUND

Financial institutions often maintain multiple accounts for each of their customers. For example, a given banking customer may hold a checking, savings, credit card, loan account, mortgage, and brokerage account at the same bank. Typically, financial institutions monitor transactions being performed by their customers to determine whether erroneous, fraudulent, illegal, or other improper transactions are taking place on accounts they maintain. If such transactions are detected, the financial institution may take appropriate action, which may include limiting use of the affected account(s).

Banking services customers may have relationships with multiple banks or financial institutions as well as multiple non-financial institutions. Accordingly, customers may use their devices (e.g., mobile and non-mobile computing devices) to access multiple accounts across the multiple financial and non-financial institutions.

### SUMMARY

This disclosure describes techniques for performing a distributed device trust determination, including determination of trust scores for customer devices across multiple organizations (e.g., financial and non-financial institutions). In some examples, a computing device of a first organization may gather data in response to a user device event (e.g., an access request) by a user device (e.g., mobile and non-mobile computing devices) and determine an organization confidence level for the user device, where the organization confidence level may indicate a level of trust associated with the user device based on the gathered data. Computing devices of other organizations may similarly determine organization confidence levels for the same user device based on other user device events by the same user device. In accordance with the disclose techniques, a distributed trust provider system receives data of the user device events including organization confidence levels for the user device from one or more organizations, and determines a common confidence level for the user device based on the data received from across the one or more organizations. The distributed trust provider system may be operated by or under the control of an entity that is separate from or otherwise independent of the one or more organizations.

In response to receipt of the user device events, the distributed trust provider system updates or creates an entry for the user device in a device registry based on the received data of the user device events, where the entry includes a common device identifier, one or more common data elements of the user device, and the common confidence level for the user device. The distributed trust provider system provides feedback including the common confidence level of the user device to the organizations in response to receipt of the user device events. In some examples, the distributed trust provider system may also provide proactive feedback to the organizations to report a status change of the user device, e.g., the user device being reported as lost or stolen.

The distributed trust provider system analyzes the updated common data for the user device to make assessments about the security and/or trustworthiness of the user device, including assessments about whether the user device is, or may be, associated with fraud. The distributed trust provider system may make such assessments in real-time, e.g., during an access request device event at the first organization, and output the common confidence level in real-time for use by the individual organizations to determine how to handle the access request by the user device.

Although each organization may perform its own analytics to determine the organization-specific confidence levels for the user device, the distributed trust provider system disclosed herein may be in a better position to make at least some assessments about the user device. For example, if the distributed trust provider system receives data of a user device event by the same user device from at least one of the other organizations, the distributed trust provider system may be able to identify fraudulent behavior associated with the user device that might not be apparent based on the data available to each of the organizations individually.

In one example, this disclosure is directed to a computing system comprising a memory storing a device registry comprising a plurality of entries for a plurality of user devices across one or more organizations, and one or more one or more processors in communication with the memory. The one or more processors are configured to receive, from a computing device of a first organization, data of a user device event including an organization confidence level for a user device associated with the user device event, update common data in an entry for the user device in the device registry based on the received data of the user device event and the organization confidence level for the user device, determine a common confidence level for the user device based on the common data in the entry for the user device in the device registry, and output, to the computing device of the first organization, the common confidence level for the user device for use by the computing device of the first organization to determine how to handle an access request from the user device.

In another example, this disclosure is directed to a method comprising receiving, by a computing system and from a computing device of a first organization, data of a user device event including an organization confidence level for a user device associated with the user device event, updating, by the computing system, common data in an entry for the user device in a device registry based on the received data of the user device event and the organization confidence level for the user device, wherein the device registry comprises a plurality of entries for a plurality of user devices across one or more organizations, determining, by the computing system, a common confidence level for the user device based on the common data in the entry for the user device in the device registry, and outputting, by the computing system and to the computing device of the first organization, the common confidence level for the user device for use by the computing device of the first organization to determine how to handle an access request from the user device.

In a further example, this disclosure is directed to a non-transitory computer-readable medium comprising instructions that, when executed, cause one or more processors to receive, from a computing device of a first organization, data of a user device event including an organization confidence level for a user device associated with the user device event, update common data in an entry for the user device in the device registry based on the received data of the user device event and the organization confidence level for the user device, determine a common confidence level for the user device based on the common data in the entry for the user device in the device registry, and output, to the computing device of the first organization, the common confidence level for the user device for use by the computing device of the first organization to determine how to handle an access request from the user device.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a block diagram illustrating a system in which multiple organizations provide data to a distributed trust provider system to enable cross-entity analysis of such data, in accordance with one or more aspects of the present disclosure.

FIG. 2 is a block diagram illustrating another example of the system of FIG. 1, in accordance with one or more aspects of the present disclosure.

FIG. 3 is a conceptual diagram illustrating an example process in which a trigger event by a user device at an organization results in the distributed trust provider system determining an updated common confidence level for the user device, in accordance with one or more aspects of the present disclosure.

FIG. 4 is a flow diagram illustrating an example process for gathering data associated with a user device by a computing device at an organization and determining a common confidence level for the user device by the distributed trust provider system, in accordance with one or more aspects of the present disclosure.

FIG. 5 is a flowchart illustrating an example operation of a distributed trust provider system determining a common confidence level for a user device, in accordance with one or more aspects of the present disclosure.

### DETAILED DESCRIPTION

This disclosure describes aspects of a system operated by a cross-organization fraud detection entity that may work in cooperation with multiple member organizations (e.g., financial or non-financial institutions). A distributed trust provider may comprise a computing system that is configured to identify and escalate potential fraud by user devices to member organizations. The distributed trust provider may store common data of the user devices in entries of a device registry, update the common data in response to receipt of user device event data from one or more of the member organizations, and generate common confidence levels for the user devices based on the updated common data. As described herein, such a system may be effective in scenarios where the fraud might not be apparent based on activities or transactions performed by the user devices at a single organization.

As one example, a user may report their user device (in this example a smartphone) as stolen to their cellular carrier. The cellular carrier may provide data concerning the theft of the smartphone to a device registry stored within the memory of the distributed trust provider. The distributed trust provider may update an entry for the user device in the data registry to indicate a status of the user device as stolen. Responsive to the update, the distributed trust provider may output a change event associated with the update on the status of the user device (i.e., the theft of the smartphone) to one or more organizations where the user device has been used in the past, as indicated by data within the entry for the user device in the device registry. In some examples, this output may be considered proactive feedback from the distributed trust provider that is triggered in response to a status change of the user device. A trust service at a first organization may store the updated status of the user device in a cache along with other organization-specific data elements of the user device. The trust service at the first organization may take the updated status of the user device into account when determining an organization confidence level for the user device in response to a later device event by the user device at the first organization.

As another example, in response to a user device event (e.g., an access request) by the user device at the first organization, a computing device at the first organization may gather data of the user device event and determine an organization confidence level for the user device, where the organization confidence level may indicate a level of trust associated with the user device based on the gathered data. Computing devices of other organizations may similarly determine organization confidence levels for the same user device based on user device events at the respective organizations by the same user device. In accordance with the disclose techniques, the distributed trust provider receives data of the user device events including organization confidence levels for the user device from one or more organizations, and determines a common confidence level for the user device based on the data received from across the one or more organizations.

In response to receipt of the user device events, the distributed trust provider updates or creates the entry for the user device in the device registry based on the received data of the user device events, where the entry includes a common device identifier, one or more common data elements of the user device, and the common confidence level for the user device. The distributed trust provider analyzes the updated common data for the user device to make assessments about the security and/or trustworthiness of the user device, including assessments about whether the user device is, or may be, associated with fraud, which are reflected in the common confidence level for the user device. The distributed trust provider device may make such assessments in real-time, e.g., during the access request device event at the first organization. The distributed trust provider outputs the common confidence level for the user device to the organizations in response to receipt of the user device events. In some examples, this output may be considered reactive feedback from the distributed trust provider that is triggered in response to a login, transaction, or other access request by the user device. The distributed trust provider may output the common confidence level in real-time, e.g., for use by the first organization to determine how to handle the access request by the user device.

In some examples, the trust service at the first organization may process the feedback including the common confidence level of the user device and update the cache including the organization-specific data of the user device. The trust service at the first organization may utilize the common confidence level received from the distributed trust provider to determine how to handle the access request by the user device. For example, returning to the above example in which the user device was reported stolen, the common confidence level for the user device may be relatively low based on the user device previously being reported as stolen and now being used to request access to the user's accounts at the first organization. In response to the common confidence level for the user device being lower than a threshold set by the first organization as being consistent with an elevated risk of fraud, the trust service at the first organization may deny access or request additional authentication from the user device prior to allowing access to the user's accounts. The trust system may also update the organization confidence level for the user device stored in the cache based on the common confidence level received from the distributed trust provider. In this way, even though the first organization may not have directly received any notification from the user regarding the theft of the user device, the first organization may be notified through the distributed trust provider in order to prevent fraudulent activity that may originate from use of a user device that was previously reported as stolen.

In examples described herein, each member organization may share some aspects of their organization-specific data with the distributed trust provider, and in addition, such member organizations may subscribe to (i.e., receive) data distributed by the distributed trust provider. Each user device registered with a customer and/or an account at one of the organizations may be assigned (e.g., by the distributed trust provider) a federated or common identification code (“common ID”) that may be used across all of the member organizations where each user device is registered. The common ID may associate device events of the user device with a specific customer and/or account, but does not identify the customer or the account, or reveal any other information about the customer or the account. The distributed trust provider may use the common ID to track activity of the user device across all of the member organization to, for example, identify potential fraud that might not be apparent just based on activity by the user device at one of the organizations. The distributed trust provider may associate devices with a customer's common ID. For example, the common ID of a customer may be associated with a tablet computing device that the customer has utilized to access their bank accounts through a banking application. In an additional example, the common ID may be associated with a cellular carrier regarding a user's cell phone.

Financial institutions normally avoid sharing data with other competitor financial institutions. Similarly, customers of such financial institutions normally prefer to avoid, at least for privacy reasons, sharing of their own data, particularly across multiple financial institutions. Such an institution may have policies in place to ensure that sharing of data from multiple financial institutions is done without enabling customer or competitive information from one financial institution to be shared with another. For example, certain types of data (e.g., personal financial information, SSNs, etc.) may not be shared beyond an on-premises computing device running a trust service of a financial institution.

Accordingly, throughout the disclosure, examples may be described where a computing system analyzes data associated with a user device, only if the computing system receives permission from the user of the user device (“customer,” “consumer,” or “account holder”) to analyze the data. For example, in situations described or discussed in this disclosure, before a computing system may collect or make use of data associated with a user device, the user of the user device may be provided with an opportunity to provide input to control whether programs or features of any such computing system can collect and make use of user device information or to dictate whether and/or how to the information collected by the system may be used. In addition, certain data may be treated in one or more ways before it is stored or used by any computing system, so that personally-identifiable information is removed. For example, a user device identifier may be treated so that no personally identifiable information can be determined about the user, or a user device's geographic location may be generalized where location information is obtained (such as to a city, ZIP code, or state level), so that a specific location of the user cannot be determined. Thus, the user may have control over how information is collected about the user device and used by all computing systems.

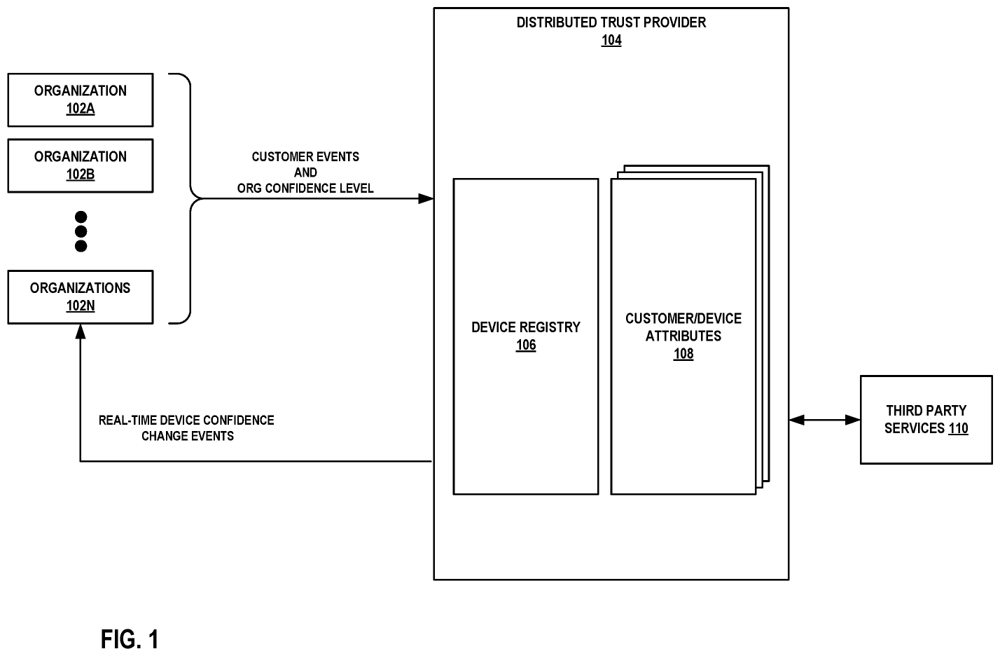

FIG. 1 is a block diagram illustrating a system in which multiple organizations provide data to a distributed trust provider system to enable cross-entity analysis of such data, in accordance with one or more aspects of the present disclosure. FIG. 1 illustrates the example operation of the system and exchanges of data that may take place between distributed trust provider system 104, organizations 102A-102N (collectively, “organizations 102”), and third party services 110. Distributed trust provider 104 may execute on one or more of servers, desktop computers, virtualized computing environments, clustering computing systems, cloud computing systems, or other such computing environments. Distributed trust provider 104 includes a device registry 106 comprising a plurality of entries for a plurality of user devices across one or more organizations where each entry stores one or more customer/device attributes 108.

Device registry 106 may include a log of all devices associated with a customer. Device registry 106 may include records received from third party services 110 and organizations 102. For example, distributed trust provider 104 may store information from a cellular carrier regarding a user acquiring a new smartphone in device registry 106 and customer/device attributes 108 along with data associated a common ID with the device. In one example, a user may log into a mobile application of organization 102A for the first time on the user's tablet computer. Organization 102A may then provide data regarding the user's tablet computing device to distributed trust provider 104 which may then update device registry 106 with the user's tablet computing device. Additionally, in the case of a first time usage of a device by a customer for the particular application, organization 102A may adhere to a Define Trust on First Use (TOFU) group of rules to enable quick determination of a new device's confidence ranking. Device registry 106 may store a customer device as an object with an object identifier and a composite of normalized un-tagged values. Additionally, device registry 106 may store some select tagged value to the device object such as phone numbers and geolocation data.

Customer/device attributes 108 may include a version number mapped to each specific version of a score calculation for a given device object. When a new device is added to device registry 106, each contributor of data regarding the new device to device registry 106 may define a confidence level of that device based on their individual tag values in customer/device attributes 108. Further, customer/device attributes 108 may include common data regarding the customer such as various customer attributes.

Third party services 110 may include one or more organizations or businesses that may provide data to distributed trust provider 104. Third party services 110 may include cellular carriers, device manufacturers, other businesses, and other organizations. Third party services 110 may share data such as device details, common confidence level, device events, and other information regarding the customer's device. The data shared to distributed trust provider 104 by third party services 110 and/or organizations 102 may be collected via a common software development kit (SDK) or private implementation that utilizes a common normalized model. Further, the data shared by third party services 110 to distributed trust provider 104 may be compiled into common data shared by distributed trust provider 104 with organizations 102 and third party services 110.

Distributed trust provider 104 may store data regarding customer devices in customer/device attributes 108. Distributed trust provider 104 may store data regarding one or more attributes of customer devices, maintain independent customer device identity keys, and aggregate common confidence levels across organizations. An example illustration of attributes that may be stored and the manner in which they may be stored in customer/device attributes 108 is illustrated below:

```
entity: common-customer-id
  devices: [
    device-1 {
      commonDeviceId: 4299a4dde59dff52959a08e33f51bb350484d6768723e5880633
      manufacturer: Apple
      osName: iOS
      osVersion: 15.0.1
      modelName: iPhone13,4
      carrier: Xfinity Mobile
      devicePhoneNumber: 555-555-1212
      orgsWhereDeviceUsed: Org1, Org3, Org8
      deviceAssociatedWithFraud: No
      confScore: 0.4
      confScoreVer: 113
      confScoreDateTime:
      confScoreContribOrg: Org3
```

In the above example, multiple attributes of a customer's cellular device have been recorded and stored in customer/device attributes 108. As illustrated above, distributed trust provider 104 may assign a common device ID to the customer's device. Additionally, distributed trust provider 104 may track one or more attributes of a customer's device such as device manufacturer, OS version, cellular carrier, location where the device was last used, common confidence level of the device, whether the device has been flagged for fraudulent user, and other factors some of which may not be illustrated. Distributed trust provider 104 may further store attributes such as the ID of devices registered to a user, phone numbers of a user, organizational data regarding the user, and other such user attributes.

The data shared by each of third party services 110 and organizations 102 with distributed trust provider 104 may pertain to financial account usage information, transactions data, and/or other financial activity data performed by user devices registered to the user. In some examples, organizations 102 may be organized as a joint venture or partnership of various entities. Organizations 102 could be organized as a non-profit organization. In other examples, organizations 102 may be private, for-profit independent entities. Organizations 102 may limit the data they share with distributed trust provider 104 and, by extension, third party services 110. For example, organizations 102 may not share confidential information or information protected by regulatory or privacy schemes with third party services 110.

Distributed trust provider 104, responsive to one or more changes in the common confidence level of a user device and/or common data of the user device, may provide an updated common confidence level and common data to one or more of organizations 102. Distributed trust provider 104 may provide one or more changes in common confidence levels in real-time to organizations 102 and/or as a data stream to organizations 102. The real-time streaming of changes in common confidence levels may enable real-time fraud detection by organizations 102. Additionally, organizations 102 may report device events and organizational confidence levels in real-time to distributed trust provider 104 as data of a device event. In an example, organization 102A detects that a user device is making multiple high-value transactions that do not match to prior customer behavior. Organization 102A may downgrade the organization confidence level of that user device and report the downgraded organization confidence level to distributed trust provider 104 along with data regarding the change in customer behavior. Responsive to the device event reported by organization 102A, distributed trust provider 104 may provide an updated common confidence level and updated common data to the organizations 102.

Although techniques described herein may apply to many types of data and business entities, each of organizations 102 is primarily described herein as a separately or independently-operated financial institution or bank. In such examples, organization 102A may be an association of multiple financial institutions or a consortium of organizations 102 that seek to share some aspects of their data and/or their customers' data to better evaluate, assess, and analyze activities of each of their respective clients and/or account holders. The data shared by each of organizations 102 with distributed trust provider 104 may pertain to financial account usage information, transactions data, and/or other financial activity data.

In many cases, customers of one bank such as organization 102A may hold multiple accounts at that bank. For example, a customer may hold one or more credit card accounts, checking accounts, loan or mortgage accounts, brokerage accounts, or other accounts at organization 102A. In addition, a customer may hold accounts at organization 102B. Generally, organization 102A will not know whether a customer holds other accounts at organization 102B or another of organizations 102, or at least will not likely be aware of all the details of accounts that the customer holds at different financial institutions. In addition, organization 102A will not likely be aware of the details of any transactions performed by the customer using accounts held by the customer at other institutions (e.g., organization 102B). Similarly, organization 102B will not likely be aware of the details of any transactions performed by the customer using accounts held by the customer at organization 102A.

Each of organizations 102 may own, operate, and/or control various computing systems. Each such computing system may be used by a respective one of organizations 102 for processing, analyzing, and administering transactions performed by account holders that entity. Such computing systems may include a distributed computing environment, cloud-based data center or any other appropriate arrangement. Each of the computing systems associated with organizations 102 may communicate with other computing systems in FIG. 1 over a network (not shown), which may, in some examples, be the internet.

Customers may engage in various transactions through their respective bank or one of organizations 102. Additionally, customers may use an application provided by one of organizations 102 to conduct various transactions on their computing device such as a smartphone or tablet computer. For instance, a customer may use their smartphone to pay for a meal at a restaurant, and then later use their tablet computer to transfer money to another account. In operation, the computing systems of organizations 102 may receive information about transactions performed by one or more customers in real time. In an example, the computing system of organization 102B receives a series of transaction data, corresponding to transactions performed by a customer using the customer's smartphone. For each such transaction, the computing system of one of organizations 102 may process the transaction data, and in doing so, perform or prepare to perform appropriate funds transfers, accounting records updates, and balance information updates associated with one or more accounts held by the customer.

The computing system of one of organizations 102 may evaluate each instance of transaction data and the device confidence level provided by distributed trust provider 104. In an example, the computing system of organization 102A, responsive to a request from a user device for a transaction, may compare the request with the confidence level provided by distributed trust provider 104. The computing system of organization 102A may determine, based on the request from the customer device and the common confidence level for the user device provided by distributed trust provider 104 whether the confidence level falls below a predetermined threshold. The computing system of organization 102A may use the value of the common confidence level for the user device relative to the threshold to determine whether to approve the transaction, deny the transaction, or require further authentication before approving the transaction. For instance, the one or more computing systems of organizations 102 may analyze each instance of transaction data and assess whether the underlying transaction has any markers or indicia of a fraudulent, illegitimate, or erroneous transaction. In a further example, in response to a determination that a user device is being used for fraudulent purposes (e.g., the user device was reported stolen and the thief is attempting to access the user's financial accounts), the computing system of organization 102A may provide a flag or other data indicia indicating fraudulent use to distributed trust provider 104. Distributed trust provider 104 may notify organizations 102 in real-time of the update to the confidence level of the user device.

In some cases, a user device may be new to one organization, but known to other organizations. In an example, a customer has used their smartphone to regularly access their banking account through organization 102A but has never used the device to access their banking account through organization 102B. When the customer first attempts to access their banking account through organization 102B, organization 102B may request the common confidence level of the user device from distributed trust provider 104. Distributed trust provider 104 may provide the common confidence level of the user device to organization 102B. Responsive to a high level of confidence from the user device's interactions with organization 102A, organization 102B may allow the device to conduct transactions without requiring further authentication that would typically be required of a new device.

The computing system of one of organizations 102 may, based on its assessment of each instance of a requested transaction and the common confidence level of a user device, act on the transaction data. If a transaction is approved, the computing system of the one of organizations 102 may finalize and/or execute any funds transfers and updates made to accounting records and/or balance information associated with accounts held by the user. If a transaction is denied, the computing system of the one of organizations 102 may perform fraud mitigation and issue notifications relating to the denied transaction. Such fraud mitigation may include modifications and/or updates to accounting and/or balance information. Notifications relating to the denied transaction may involve the computing system of one of organizations 102 sending alerts or other communications to personnel employed by the one of organizations 102 and/or to the account holder. Such alerts may provide information about the transaction, may seek additional information about the transaction from the customer, and/or prompt an analysis of the transaction by fraud analysis personnel.

In a similar manner, distributed trust provider 104 and organizations 102 may receive information about transactions performed by one or more of its own customers, and each respective computing system of organization 102 may perform similar operations relating to transactions each has processed on behalf of organizations 102. For instance, the computing system of organization 102A may process transactions performed by each of customers and provide security details to other of organizations 102 via distributed trust provider 104. The computing systems of organizations 102 may also evaluate such transactions and determine whether any transaction shows signs of being a fraudulent, illegitimate, or erroneous transaction. Each of the computing systems of organizations 102 may act on such evaluations (e.g., approving or deny of the transaction) in a manner similar to that described above in connection with transaction data corresponding to activity of the customer.

In accordance with one or more aspects of the present disclosure, each of the computing systems of organizations 102 may generate summarized or abstracted versions of transaction data and customer device usage. In an example, the computing system of organization 102A collects instances of transaction data and performs an abstraction operation to generate abstracted transaction data. Such an operation removes from instances of transaction data information that can be used to identify a customer (the person responsible for the transactions). The computing system of organization 102A may determine if the transaction data relates to a customer or device event. The computing system of organization 102A may then provide the event data to distributed trust provider 104. The computing system of organization 102A may provide the data to distributed trust provider 104 in real time to assist in preventing simultaneous fraud at other organizations 102N.

Data generally represented in FIG. 1 as “customer events and org confidence level” may be mutually beneficial if shared with other lines of business within a given entity such as organization 102A or organizations 102. Yet such data also represents and/or includes private customer data, competitive information, and/or trade secret information. If such data is abstracted, it may be easier for each of organizations 102 to share the data, and for distributed trust provider 104 to distribute data to organizations 102 and third party services 110. Abstraction may include creating flags with date and time stamps for specific fraud markers, such as velocity, repeated authorization amounts, geographic disparity, etc., generally and by product. The abstraction may be leveraged to help mitigate fraud by attenuating the fraud losses from a particular event.

In some examples, distributed trust provider 104 may include a central repository where each customer's profile may be populated by the member institutions with customer account/transaction information. Distributed trust provider 104 may determine, based on data from one or more of organizations 102 or third party services 110, that fraud may be occurring on accounts associated with customer 110. Additionally, one of the computing systems of organizations 102 may independently make such a determination based on a deterministic algorithm. In other examples, however, one of the computing systems of organizations 102 may merely determine that fraud is likely occurring using one or more devices associated with a customer and rely on a human analyst to confirm the finding.

The computing systems of one or more of organizations 102 may notify distributed trust provider 104 that fraud is occurring using one or more devices associated with a customer. For instance, still continuing with the example being described in connection with FIG. 1, a computing system of one of organizations 102 determines that fraud is occurring on one or more devices associated with a customer. The computing system may output the customer event regarding the fraud to distributed trust provider 104. Distributed trust provider 104 may then provide a real-time update of the user device's common confidence level to organizations 102 and third party services 110 to ensure that appropriate personnel or computing systems receives, views, and/or acts on the data in a timely manner.

In some examples, the common confidence level for a user device stored in the memory of distributed trust provider 104 may take the form of a score (e.g., 0-100), category (green, yellow, red), or rating (“no fraud suspected” or “fraud suspected”) that provides an indication of the results of the fraud assessment performed by the computing systems of organizations 102 and/or third party services 110. Such an assessment might range from “no fraud suspected” (or “green” or “0”) to “fraud suspected” (or “red” or “100”). In some examples, the data in customer/device attributes 108 may also include information about the nature of the activity underlying the score, although in other examples, such information might be omitted where it could (or to the extent it could) reveal competitive information about other organizations 102. Distributed trust provider 104 may modify or clean such modeling information before it is sent to organizations 102 or third party services 100 to ensure that such modeling information does not provide any information that one or more of organizations 102 or third party services 110 can use to derive competitive, trade secret, or customer information.

Accordingly, in FIG. 1, since a customer may hold accounts at both organizations 102A and 102B, distributed trust system 104 may include abstracted transaction data from both organizations 102A and 102B. In some examples, cross-organizational data of this nature could be provided to each of organizations 102 on a subscription basis. In a manner similar to the modeling data described above, each of organizations 102 may use such subscription data to enhance their own transaction analysis analytics and modeling. For example, organization 102A may use such subscription data to augment the data it uses in its analytics and modeling, and may use it to learn more about its own customers, their tendencies, their devices, and to more accurately identify potentially erroneous, fraudulent, or illegitimate transactions. Additionally, the added data accessible to distributed trust provider 104 may reduce organizations' needs for sampling data from a customer device.

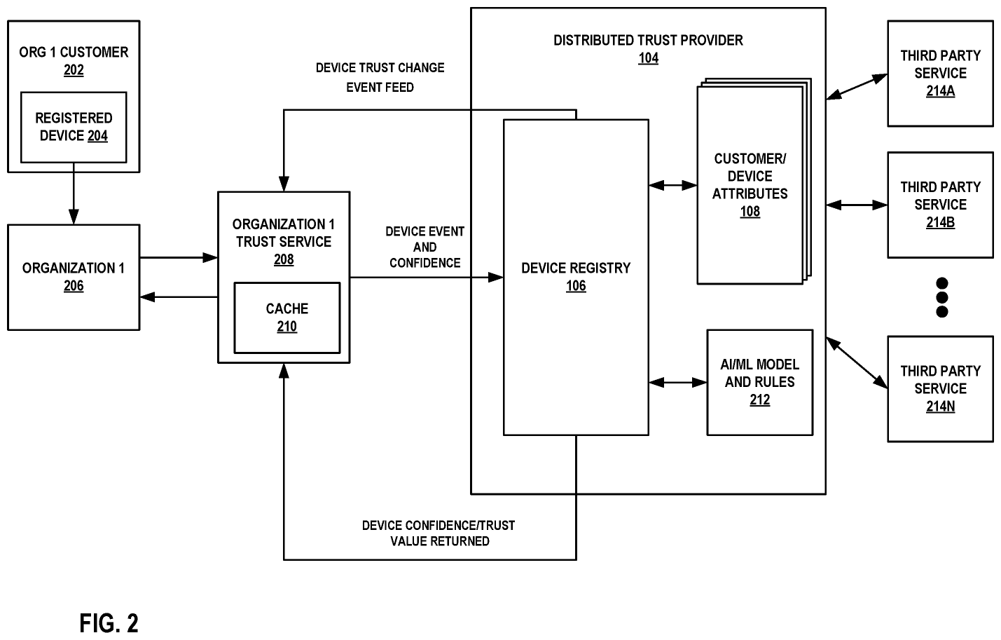

FIG. 2 is a block diagram illustrating another example of the system of FIG. 1. A customer of organization 206 (which may be a financial institution and include one or more computing systems) is represented by org 1 customer 202. Org 1 customer 202 may have a device, illustrated here as registered device 204, (such as a smartphone, tablet computer, laptop computer, desktop computer, or other device) associated with the customer and used by org 1 customer 206 to conduct activities such as banking (registered device 204 may be used for any range of activities but for ease of illustration will be explained as used for banking hereinafter).

Organization 1 206 may utilize organization trust service 1 208 to determine the confidence level of devices used by customers such as org 1 customer 202 to interact with organization 1 206's computing systems and services. Organization 1 206 may use organization 1 trust service 208 to determine whether customer devices are subject to fraudulent activity and whether further actions should be taken such as requiring additional authentication or denying transaction requests originating from the suspect devices. Organization 1 206 may determine that a trigger event (e.g., new login, theft of a device, unusual transaction, and other such events) has occurred and initiate a process of determining a common confidence level in real-time. Additionally, organization 1 trust service 208 may enable organization 1 206 to determine which of a customer's devices are susceptible to fraud and to avoid blocking customer devices that remain clear of such fraudulent use. Organization 1 trust service 208 may execute on one or more computing devices such as on-premise servers, cloud computing, cluster computing, desktop computers, and other computing devices.

Organization 1 trust service 208 may store data regarding customer devices such as registered device 204 in cache 210. Cache 210 may be memory contained within the computing systems of organization 1 trust service. Cache 210 may store one or more attributes of customers and customer devices. Cache 210 may additionally store updates from distributed trust provider 104. For example, org 1 customer 202 may register a device with a high confidence rating for the first time with a different organization than organization 1 206. Cache 210 may enable organization 1 206 to operate independently in checking devices for confidence level should communications with distributed trust provider 104 be interrupted. Additionally, cache 210 may enable organizations to execute multi-factor authentications without a call to an intermediary such as distributed trust provider 104. Distributed trust provider 104 may provide the information regarding the newly registered device to organization 1 trust service 208 such that organization 1 206 may recognize the device without org 1 customer 202 needing to register the device with organization 1 206. Additionally, organization 1 trust service 208 may provide information from cache 210 to distributed trust provider 104 regarding customers and their associated devices. Organization 1 trust service 208 may be configured to limit the sharing of confidential information such as SSNs with distributed trust provider. Organization 1 trust service 208 may include a series of rules limiting the data that organization 1 trust service 208 may share with other organizations. An example of data collected and processed by organization 1 trust service 208 is illustrated below (with the common data model attributes omitted for brevity):

entity:

```
Org-customer-id
  devices: [
    device-1 {
      orgDeviceId: 4bb80484d6768723e5880633a161b22964299a4dde59dff52959a08e33f
      channelsWhereDeviceUsed: MobileApp, OnlineWWW
      geoHistoryCenter: 46°11′19.4″N 94º33′40.2″W
      lastProfileEmailChangeDate:
      lastMfaDate:
      normalHoursOfUse:
      language: en
      lastChannelUsed: MobileApp
      lastChannelUsedVer: 3.331
      lastChannelUsedInstallDate:
      lastChannelUsedBiometricAuth: True
      orgConfScore: 0.4
      orgConfScoreVer: 233
      orgConfScoreDateTime:
```

As illustrated in FIG. 1 and FIG. 2 distributed trust provider 104 includes device registry 106 and customer/device attributes 108. Distributed trust provider 104 additionally include AI/ML model and rules 212 (hereinafter model 212). Model 212 may determine the common confidence level of customer devices such as registered device 204. Model 212 may use one more machine learning and AI models to determine common confidence levels for customer devices. Model 212 may use data from device registry 106 and customer/device attributes 108 to determine the common confidence level of a device. Model 212 may use confidence determinations from organization 1 trust service 208 in determining the common confidence levels of registered devices. Additionally, model 212 may use the combined data from multiple organizations and third party services 214N to determine the common confidence level of a device. Due to the larger swath of data, model 212 may provide more accurate confidence ratings that organization trust service 208 would not be able to provide solely using the data available to organization 1 206. Model 212 may use a variety of types of data to determine the common confidence level of a device such as tagged data, cookies, and untagged data.

Model 212 may use one or more data models to organize the information. Further, model 212 may output the score calculation as a server SDK or containerized image for use by organization 1 206 or organization 102N. Model 212 may additionally rate a device with a low confidence ranking if the device is new to all of the organizations connected to distributed trust provider 104. Model 212 may rank a completely new device as low confidence due to risk of bad actors spoofing new devices and attempting to access customer information with the spoofed device.

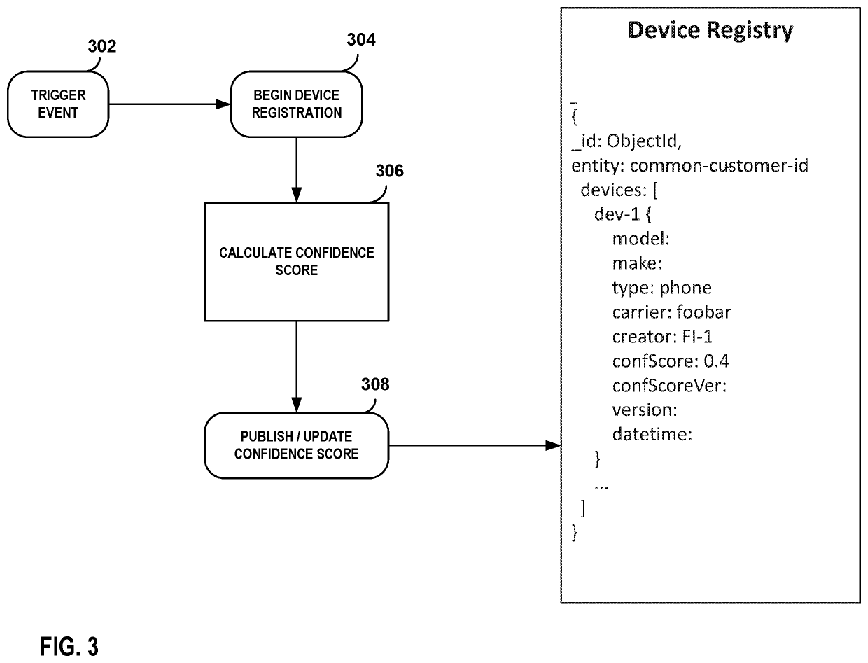

FIG. 3 is a conceptual diagram illustrating an example process in which a trigger event by a user device at an organization results in the distributed trust provider system determining an updated common confidence level for the user device.

An organization may determine that a user device event has occurred and respond accordingly (302). A user device event may occur when one or more criteria are met such as the registration of a new device, an access request by a user device, a transaction request by a user device, a report that a user device has been stolen, and other events. Responsive to the detection of an event, the computing system(s) of an organization may begin registration of the device event and/or of the device itself (304). Following registration, the computing system(s) of the organization may compute an organization confidence level for the user device. The confidence level may be determined according to common score calculation rules that are defined and adhered to by all the computing systems of the member organizations. The computing system(s) may use one or more attributes to compute the organization confidence level. The computing system(s) may use data stored locally on the computing system(s) or may use data received from a distributed trust provider to compute the organization confidence level. Responsive to the computation of the organization confidence level, the computing system(s) may publish or update the organization confidence level to the distributed trust provider (308). Additionally, the organization may update their records with the organization confidence level for the user device. The distributed trust provider then uses the organization confidence level for the user device to determine an updated common confidence level for the user device and stores the updated common confidence level in an entry of the user device in the device registry.

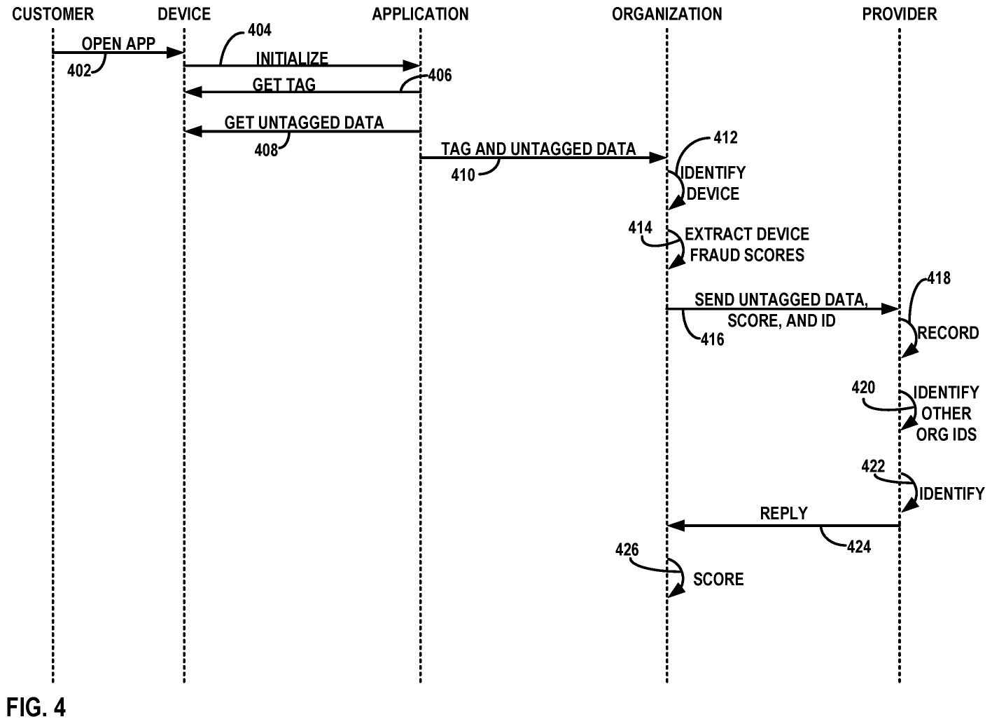

FIG. 4 is a flow diagram illustrating an example process for gathering data associated with a user device by a computing device at an organization and determining a common confidence level for the user device by the distributed trust provider system.

In the example, a customer opens an organization's application on their computing device (e.g., smartphone, tablet computer, laptop computer, desktop computer, etc.), such as registered device 204 as illustrated in FIG. 2 (402). For example, registered device 204 may receive user input consistent with the customer requesting that registered device open a banking application. The customer's device initializes the application (404). Responsive to the initialization, the application acquires a device tag from the customer's device (406). The application may acquire tagged device identifiers that include a token/UUID/attestation that can be stored on the organization's application (e.g., a sandbox/browser). A limitation on tagged device identifiers is that the tag may only be accessed by the setting organization (i.e., application of a first organization cannot read a value set by application of a second organization), therefore the tag may be private. The application may collect as much untagged data allowed by the device's rules such a geolocation, IP address, time and date, and other untagged information (408). Untagged values may be accessible to any/all applications within a given device (i.e. browser navigator/UI device). A limitation on untagged values is that entropy may be too large to confidently identify a device. The application executing on the customer's device sends the untagged data and the tag to the one or more computing devices of the organization (410). For example, the application may send the data to a trust service, such as organization 1 trust service 208, executed by the organization's computing systems or computing devices.

The organization's computing devices utilize the untagged data and the tag to identify the device (412). The organization's computing devices may then extract fraud scores of the device from the one or more device databases connected to the organization's computing devices (414). The organization's computing devices may extract fraud scores that are indicative of a likelihood that registered device 204 has been hijacked, stolen, or is otherwise untrustworthy.

The organization's computing devices provide the untagged data, the fraud score, the tag, and a device ID to the distributed trust provider (416). The organization's computing device may filter the data before sending it to the distributed trust provider in accordance with privacy and data confidentiality requirements to ensure that sensitive data is not made accessible to other organizations. The organization's computing device may forward the data to a distributed trust provider such as distributed trust provider 104 as illustrated in FIG. 2. The organization's computing device may forward the data in order to obtain an updated common confidence level that reflects a shared confidence level among one or more organizations regarding the trustworthiness of registered device 204.

Responsive to the receipt of untagged data, the fraud score, the tag, and the device ID, distributed trust provider 104 records the data in a database such as customer/device attributes 108 (418). Distributed trust provider 104 identifies the IDs of other organizations such as banks that the customer device may be associated with (420). For example, distributed trust provider 104 identifies the IDs from a registry of IDs and other data maintained by distributed trust provider 104.

Responsive to the identification of the other bank IDs, distributed trust provider 104 identifies a common confidence level for the customer device (422). For example, distributed trust provider 104 identifies a common confidence level for a particular device that represents a shared level of confidence in the device. Distributed trust provider 104 replies to the organization's request with the confidence level in an identification of the customer's device (424). Finally, the organization's computing devices may utilize both data stored on the organization's computing devices as well as the data received from distributed trust provider 104 to compute a final confidence level (426). For example, the organization's computing device may determine not to allow access to personally identifiable information of the customer by registered device 204 based on a low confidence level of registered device 204. In another example, the organization's computing devices may determine that, due to a threshold confidence level being reached by registered device 204, registered device 204 is allowed to access one or more financial accounts of the associated customer.

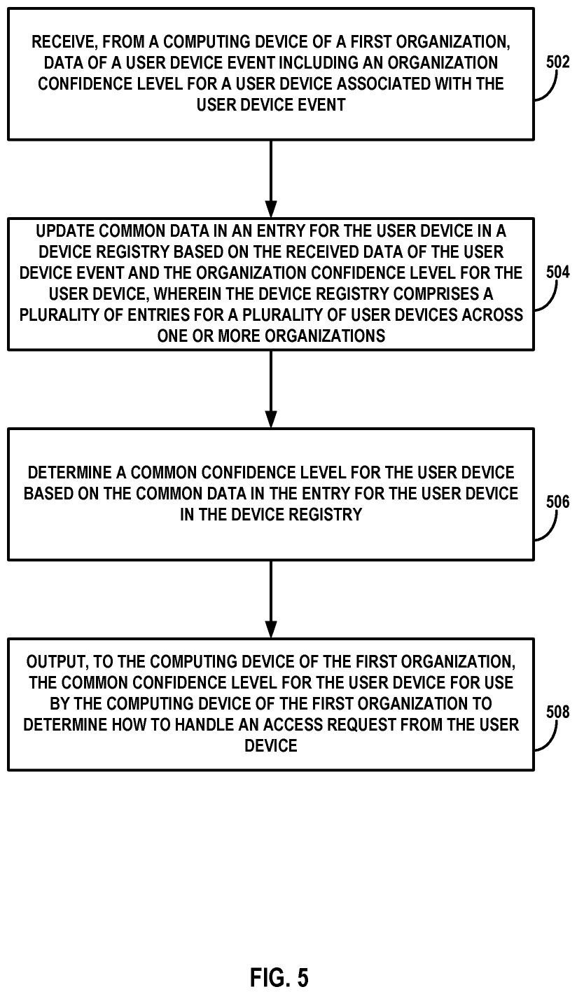

FIG. 5 is a flowchart illustrating an example operation of a distributed trust provider determining a common confidence level for a user device. For the purposes of clarity, FIG. 5 is described in reference to distributed trust provider 104 from FIG. 2.

A computing system, such as distributed trust provider 104, receives from a computing device of a first organization, such as organization 1 trust service 208, data of a user device event including an organization confidence level for a user device, such as registered device 204, associated with the user device event (502). For example, organization 1 trust service 208 may receive an indication that a user such as org 1 customer 202 is trying to log into a banking application via registered device 204. In another example, distributed trust provider 104 receives a data regarding registered device 204 attempting to access personally identifiable information controller by the first organization.

Distributed trust provider 104 updates common data in an entry for registered device 204 in a device registry, such as device registry 106, based on the received data of the user device event and the organization confidence level for registered device 204, wherein device registry 106 comprises a plurality of entries for a plurality of user devices across one or more organizations (504). For example, distributed trust provider 104 may update common data that reflects shared data regarding registered device 204 that is obtained from one or more organizations. Distributed trust provider 104 may update data regarding one or more attributes of registered device 204 that is stored in customer/device attributes 108.

Distributed trust provider 104 determines a common confidence level for registered device 204 based on the common data in the entry for registered device 204 in device registry 106 (506). For example, distributed trust provider 104 may determine the common confidence level based on one or more factors and corresponding common data in the entry for registered device 204. In another example, distributed trust provider 104 may determine a relatively low confidence level for registered device 204 if registered device 204 has been reported as stolen. In yet another example, distributed trust provider 104 may determine a relatively high confidence level based on registered device 204 being reported as trustworthy by multiple organizations.

Distributed trust provider 104 outputs, to organization 1 trust service 208, the common confidence level for registered device 204 for use by organization 1 trust service 208 to determine how to handle an access request from registered device 204 (508). For example, distributed trust provider 104 may output a relatively low confidence level to organization 1 trust service 208. Organization 1 trust service 208, responsive to receiving the relatively low confidence level, may refuse an access request from registered device 204. In another example, distributed trust provider 104 provides a relatively high confidence level to organization 1 trust service 208. Organization 1 trust service 208, responsive to receiving the relatively high confidence level, grants access for registered device 204.

As a general summary, the disclosed method and system will be an organization-wide registry of customers and their associated device identifying data, integrated with an industry consortium maintained distributed trust provider service. The crowdsourcing of customer device data across an industry will provide an aggregated data set feeding an artificial intelligence and machine learning (AI/ML) model which will provide a higher level of accuracy as compared to what a single organization could produce and will thereby reduce the time required to flag high risk, low confidence devices across the industry. This system would include a consistent customer device data attribute model which is key to aggregating data across organizations.

Customer device trust changes will be ingested by the organization from the distributed trust provider in real-time as they occur and the organization will also send customer device trust event data including a device confidence level to the distributed trust provider. The centralized distributed trust provider will leverage third party customer and device data sources to augment the aggregated customer device trust data. The organization can use this customer device trust data to allow, block, challenge or defer customer requested operations. The organization will maintain a local cache of customer device data to improve performance and resiliency.

The disclosed solution provides real-time customer device identification data to reduce the time needed to identify exploited device risk or trust changes. This solution also solves for the lack of industry-standard customer device data model which will improve efficiency of each participating organization. The solution ensures resiliency and performance by incorporating a local cache of data so that each organization can operate independently in a degraded mode if the distributed trust provider is unavailable. The disclosed solution provides a solution arising from the current lack of available timely device trust and risk data, which makes it difficult to identify when a device has been compromised or when a customer is being impersonated on a device which is not theirs. The disclosed solution may be applicable to any high risk or regulated industry requiring varying levels of trust and privilege for activities with different levels of risk and whose users leverage mobile devices.

The technique of this disclosure may provide several advantages and benefits. For example, the distributed trust provider may reduce the time needed to detect device risk. This reduction in time may be due to crowdsourced device data that enables immediate sharing of risk data when first detected, streamed device trust change events that allow real-time fraud detection, and a central AI/ML model that can leverage the full population of devices across member organizations. As another example, the organization local cache ensures resiliency and performance because the organization can operate independently in a degraded mode if the distributed trust provider is unavailable and the cached risk data enables fast multifactor authentication decisions without making a call to the distributed trust provider. As a further example, improved efficiency and consistency is possible due to the distributed trust provider's consolidation of third-party risk/trust sources, which reduces each organization's need for the same.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

For ease of illustration, only a limited number of devices are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The figures included herein each illustrate at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the figures and/or may include additional devices and/or components not shown in the figures.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific figures, such systems, devices, and/or components may be implemented in a number of different ways. For instance, one or more devices illustrated in the figures herein as separate devices may alternatively be implemented as a single device; one or more components illustrated as separate components may alternatively be implemented as a single component. Also, in some examples, one or more devices illustrated in the figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, or optical disk storage, magnetic disk storage, or other magnetic storage devices, flash memory, or any other medium that can be used to store desired program code in the form of instructions or data structures and that can be accessed by a computer. Also, any connection may properly be termed a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

What is claimed is:

1. A system comprising:
a memory storing a device registry comprising a plurality of entries for a plurality of user devices across one or more organizations; and
one or more processors in communication with the memory, the one or more processors configured to:
receive, from a computing device of a first organization, data of a user device event including an organization confidence level for a user device associated with the user device event;
update common data in an entry for the user device in the device registry based on the received data of the user device event and the organization confidence level for the user device;
determine a common confidence level for the user device based on the common data in the entry for the user device in the device registry; and
output, to the computing device of the first organization, the common confidence level for the user device for use by the computing device of the first organization to determine how to handle an access request from the user device.

2. The system of claim 1, wherein the one or more processors are configured to:
receive an update on a status of the user device from a third-party service or at least one of the one or more organizations; and
in response to receipt of the update on the status of the user device, output, to the computing device of the first organization from which the device event associated with the user device has been received, a change event associated with the update on the status of the user device.

3. The system of claim 1, wherein to determine the common confidence level for the user device, the one or more processors are configured to use a machine learning-based model to:
compare one or more elements of the received data of the user device event and one or more elements of the common data in the entry for the user device in the device registry; and
determine the common confidence level for the user device based on the comparison and the organization confidence level for the user device.

4. The system of claim 1, wherein in response to the common confidence level for the user device being lower than a threshold set by the first organization as being consistent with an elevated risk of fraud, the common confidence level is used by the computing device of the first organization to request additional authentication from the user device.

5. The system of claim 1, wherein the one or more processors are configured to, in response to receipt of the user device event, receive identity information for the user device associated with the user device event from one or more third-party services.

6. The system of claim 1, wherein the entry for the user device in the device registry includes a common device identifier that is consistent for the user device across the one or more organizations, one or more common data elements of the user device, and the common confidence level for the user device.

7. The system of claim 6, wherein the received data of the user device event includes the common device identifier mapped from an organization device identifier by the computing device of the first organization, one or more of the common data elements of the user device, one or more organization data elements of the user device, and the organization confidence level for the user device.

8. The system of claim 1, wherein to update the common data in the entry for the user device in the device registry based on the received data of the user device event, the one or more processors are configured to one of:
modify previous common data in the entry for the user device in the device registry based on the received data of the user device event and the organization confidence level for the user device, wherein the previous common data is based on previous device events received from a third-party service or at least one of the one or more organizations; or
create the entry for the user device in the device registry with a default common confidence level based on the received data of the user device event and the organization confidence level for the user device.

9. The system of claim 1, wherein to determine and output the common confidence level for the user device, the one or more processors are configured to:
determine the common confidence level for the user device in real-time during an access request device event at the first organization; and
output, to the computing device of the first organization, the common confidence level for the user device in real-time for the computing device of the first organization to determine how to handle the access request from the user device.

10. A method, comprising:
receiving, by a computing system and from a computing device of a first organization, data of a user device event including an organization confidence level for a user device associated with the user device event;
updating, by the computing system, common data in an entry for the user device in a device registry based on the received data of the user device event and the organization confidence level for the user device, wherein the device registry comprises a plurality of entries for a plurality of user devices across one or more organizations;
determining, by the computing system, a common confidence level for the user device based on the common data in the entry for the user device in the device registry; and
outputting, by the computing system and to the computing device of the first organization, the common confidence level for the user device for use by the computing device of the first organization to determine how to handle an access request from the user device.

11. The method of claim 10, further comprising:
receiving, by the computing system, an update on a status of the user device from a third-party service or at least one of the one or more organizations; and
in response to receipt of the update on the status of the user device, outputting, by the computing system and to the computing device of the first organization from which the device event associated with the user device has been received, a change event associated with the update on the status of the user device.

12. The method of claim 10, wherein determining the common confidence level further comprises:
comparing, using a machine learning-based model, one or more elements of the received data of the user device event and one or more elements of the common data in the entry for the user device in the device registry; and
determining, using the machine learning-based model the common confidence level for the user device based on the comparison and the organization confidence level for the user device.

13. The method of claim 10, wherein in response to the common confidence level for the user device being lower than a threshold set by the first organization as being consistent with an elevated risk of fraud, the common confidence level is used by the computing device of the first organization to request additional authentication from the user device.

14. The method of claim 10, further comprising in response to receipt of the user device event, receiving, by the computing system, identity information for the user device associated with the user device event from one or more third-party services.

15. The method of claim 10, wherein the entry for the user device in the device registry includes a common device identifier that is consistent for the user device across the one or more organizations, one or more common data elements of the user device, and the common confidence level for the user device.

16. The method of claim 15, wherein the received data of the user device event includes the common device identifier mapped from an organization device identifier by the computing device of the first organization, one or more of the common data elements of the user device, one or more organization data elements of the user device, and the organization confidence level for the user device.

17. The method of claim 10, wherein updating the common data in the entry for the user device in the device registry based on the received data of the user device event further comprises one of:
modifying, by the computing system, previous common data in the entry for the user device in the device registry based on the received data of the user device event and the organization confidence level for the user device, wherein the previous common data is based on previous device events received from a third-party service or at least one of the one or more organizations; or
creating, by the computing system, the entry for the user device in the device registry with a default common confidence level based on the received data of the user device event and the organization confidence level for the user device.

18. The method of claim 10, wherein determining and outputting the common confidence level for the user device further comprises:
determining, by the computing system, the common confidence level for the user device in real-time during an access request device event at the first organization; and
outputting, by the computing system and to the computing device of the first organization, the common confidence level for the user device in real-time for the computing device of the first organization to determine how to handle the access request from the user device.

19. A non-transitory computer-readable medium comprising instructions that, when executed, cause one or more processors to:
receive, from a computing device of a first organization, data of a user device event including an organization confidence level for a user device associated with the user device event;
update common data in an entry for the user device in the device registry based on the received data of the user device event and the organization confidence level for the user device;
determine a common confidence level for the user device based on the common data in the entry for the user device in the device registry; and
output, to the computing device of the first organization, the common confidence level for the user device for use by the computing device of the first organization to determine how to handle an access request from the user device.

20. The non-transitory computer-readable medium of claim 19, wherein the instructions further cause the one or more processors to:
receive an update on a status of the user device from a third-party service or at least one of the one or more organizations; and
in response to receipt of the update on the status of the user device, output, to the computing device of the first organization from which the device event associated with the user device has been received, a change event associated with the update on the status of the user device.
